(19) United States
(12) Patent Application Publication
(10) Pub. No.: US 2021/0326775 A1
(43) Pub. Date: Oct. 21, 2021

(54) OPERATION MANAGEMENT APPARATUS, OPERATION MANAGEMENT SYSTEM, OPERATION MANAGEMENT METHOD, AND VEHICLE

(71) Applicant: TOYOTA JIDOSHA KABUSHIKI KAISHA, Toyota-shi (JP)

(72) Inventors: Yuki TATSUMOTO, Nagoya-shi (JP); Saori MATSUMOTO, Chofu-shi (JP); Keigo YAMADA, Toyota-shi (JP); Akira SASAKI, Miyoshi-shi (JP); Mitsuhiro MIURA, Toyota-shi (JP)

(73) Assignee: TOYOTA JIDOSHA KABUSHIKI KAISHA, Toyota-shi (JP)

(21) Appl. No.: 17/222,040

(22) Filed: Apr. 5, 2021

(30) Foreign Application Priority Data
Apr. 16, 2020 (JP) 2020-073571

(51) Int. Cl. G06Q 10/02; G06Q 10/06; G06Q 30/02; G06Q 50/30

(52) U.S. Cl. CPC G06Q 10/02; G06Q 10/06312; G06Q 50/30; G06Q 30/0207; G06Q 10/06315

(57) ABSTRACT

An operation management apparatus includes a controller configured to manage operation of a vehicle. The controller is configured to receive, from a terminal apparatus of a user, boarding application information including a desired condition of the user, determine an operation schedule for the vehicle so as to enable the user to board the vehicle in accordance with the desired condition, when an operation demand for the vehicle occurs, change the operation schedule based on the operation demand, and when the user is unable to board the vehicle as per the desired condition due to the change in the operation schedule made based on the operation demand, transmit, to the terminal apparatus of the user, information regarding an incentive to be granted to the user.

### CROSS-REFERENCE TO RELATED APPLICATION

This application claims priority to Japanese Patent Application No. 2020-073571 (filed on Apr. 16, 2020), the entire contents of which are incorporated herein by reference.

### TECHNICAL FIELD

The present disclosure relates to an operation management apparatus, an operation management system, an operation management method, and a vehicle.

### BACKGROUND

Vehicles which operate in accordance with demand from users are known. For example, Patent Literature (PTL) 1 discloses an operation management method for improving operation efficiency.

### CITATION LIST

### Patent Literature

PTL 1: JP 2019-016290 A

### SUMMARY

Vehicles which operate in accordance with demand from users have the characteristics of public transport. As public transport, the vehicles are required to operate so as to serve public purposes. The vehicles are also required to operate so as to serve various purposes that are not limited to public purposes.

It would be helpful to realize operation that supports various purposes.

An operation management apparatus according to an embodiment of the present disclosure includes

a controller configured to manage operation of a vehicle, wherein

the controller is configured to:

receive, from a terminal apparatus of a user, boarding application information including a desired condition of the user;

determine an operation schedule for the vehicle so as to enable the user to board the vehicle in accordance with the desired condition;

when an operation demand for the vehicle occurs, change the operation schedule based on the operation demand; and

when the user is unable to board the vehicle as per the desired condition due to the change in the operation schedule made based on the operation demand, transmit, to the terminal apparatus of the user, information regarding an incentive to be granted to the user.

An operation management system according to an embodiment of the present disclosure includes:

the operation management apparatus; and

the vehicle.

An operation management method according to an embodiment of the present disclosure is executed by an operation management apparatus configured to manage operation of a vehicle. The operation management method includes:

receiving, from a terminal apparatus of a user, boarding application information including a desired condition of the user;

determining an operation schedule for the vehicle so as to enable the user to board the vehicle in accordance with the desired condition;

when an operation demand for the vehicle occurs, changing the operation schedule based on the operation demand; and

when the user is unable to board the vehicle as per the desired condition due to the change in the operation schedule made based on the operation demand, transmitting, to the terminal apparatus of the user, information regarding an incentive to be granted to the user.

A vehicle according to an embodiment of the present disclosure is configured to:

operate based on an operation schedule and board users; and

notify a user who is on board the vehicle of information requesting early alighting when the operation schedule has been changed based on an operation demand.

According to the operation management apparatus, the operation management system, the operation management method, and the vehicle according to the embodiments of the present disclosure, operation that supports various purposes can be provided.

### BRIEF DESCRIPTION OF THE DRAWINGS

In the accompanying drawings:

FIG. 1 is a schematic diagram illustrating an example configuration of an operation management system according to an embodiment;

FIG. 2 is a block diagram illustrating an example configuration of the operation management system according to the embodiment; and

FIG. 3 is a flowchart illustrating an example of a procedure executed by a server.

### DETAILED DESCRIPTION

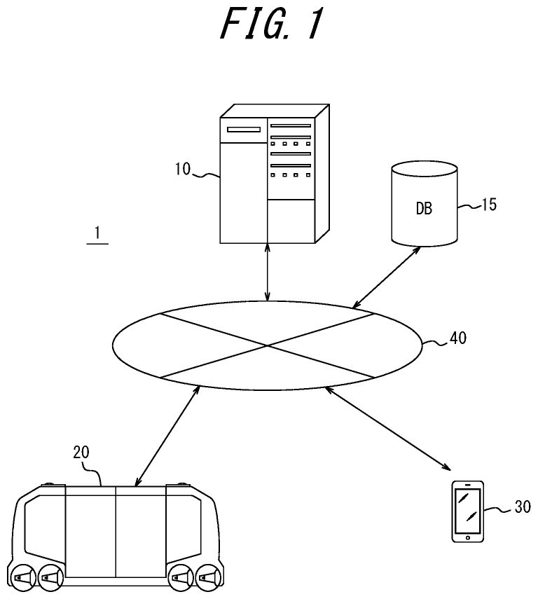

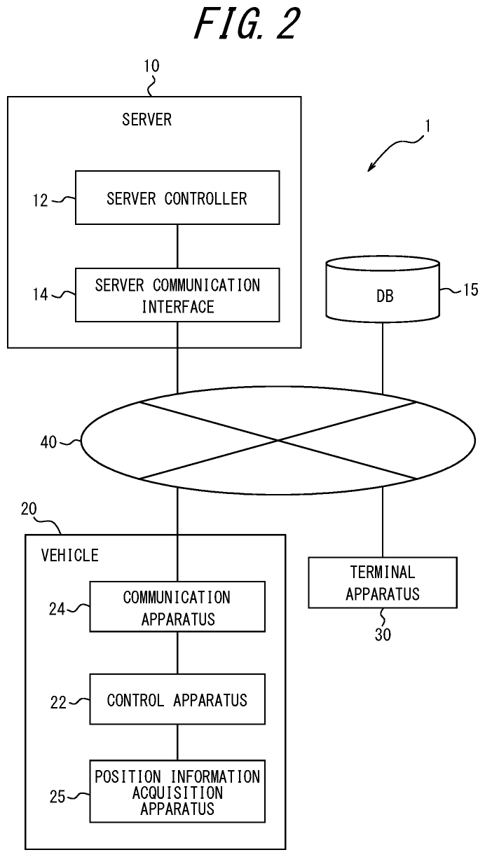

As illustrated in FIGS. 1 and 2, an operation management system 1 according to an embodiment includes a server 10, a vehicle 20, and a terminal apparatus 30. The operation management system 1 further includes a database (DB) 15, although this is not essential. The server 10, the vehicle 20, the terminal apparatus 30, and the DB 15 are connected to a network 40 and are communicable with each other. Each of the server 10, the vehicle 20, the terminal apparatus 30, and the DB 15 is not limited to one and may be two or more in number.

The operation management system 1 provides an on-demand bus service for boarding a user to the vehicle 20 and travelling between at least two points so as to transport the user. The operation management system 1 manages the operation of the vehicle 20 so that the vehicle 20 can transport the user.

The user is in possession of the terminal apparatus 30 and may apply for use of the on-demand bus service provided by the vehicle 20 by accessing the server 10 through the terminal apparatus 30.

The server 10 may accept an application from the user for boarding and determine an operation route or an operation schedule for the vehicle 20 based on the application. The server 10 may determine whether the application from the user is acceptable based on an operation status of the vehicle 20. The server 10 may determine the operation route or the operation schedule for the vehicle 20 based on the status of the application from the user. The server 10 is also referred to as an operation management apparatus.

The operation management system 1 that manages the operation of the vehicle 20 may be operated by an entity providing the on-demand bus service, or by another different entity.

The server 10 may include a single server apparatus, or a plurality of server apparatuses capable of communicating with each other. The server 10 manages the application accepted from the user. The server 10 may transmit and receive various types of information regarding the provision of the on-demand bus service to and from the vehicle 20. The server 10 may be configured to execute, in addition to the above processing, various types of processing regarding the provision of the on-demand bus service. The server 10 manages the operation of the vehicle 20. The server 10 may communicate with the vehicle 20 to thereby acquire various types of information regarding the vehicle 20, such as a position or a speed of the vehicle 20. The server 10 may be configured to execute, in addition to the above processing, various types of processing to manage the operation of the vehicle 20.

The server 10 includes a server controller 12 and a server communication interface 14. The server controller 12 may include at least one processor. The server controller 12 is also referred to simply as a controller. The “processor” in the present embodiment may be, but is not limited to, a general-purpose processor, or a dedicated processor that is dedicated to specific processing. The server controller 12 may include at least one dedicated circuit. The dedicated circuit may include, for example, a Field-Programmable Gate Array (FPGA) or an Application Specific Integrated Circuit (ASIC). The server controller 12 may include the dedicated circuit instead of the processor, or may include the dedicated circuit along with the processor. The server communication interface 14 includes a communication module and may communicate with the vehicle 20. The server 10 may further include a memory. The memory may be, but is not limited to, a semiconductor memory, a magnetic memory, or an optical memory. The memory may function as, for example, a main memory, an auxiliary memory, or a cache memory. The memory may include an electromagnetic storage medium, such as a magnetic disk. The memory may include a non-transitory computer-readable medium. The memory may store any information used for the operations of the server 10. For example, the memory may store a system program, an application program, or the like. The server 10 may store a program, information, or the like, using the DB 15 as the memory.

The vehicle 20 boards the user to operate. The vehicle 20 may be configured to allow the user to be on board. For example, the vehicle 20 may include a seat or the like that allows the user to sit. The vehicle 20 is not limited to one and may be two or more in number.

The vehicle 20 may be configured to operate using automated driving. The automated driving may be, for example, performed at any level from Level 1 to Level 5 as defined by the Society of Automotive Engineers (SAE). The automated driving may be performed based on other definitions without being limited to the exemplified definition.

The vehicle 20 includes a control apparatus 22 and a communication apparatus 24. The control apparatus 22 and the communication apparatus 24 are communicably connected to each other, for example, via an in-vehicle network, such as a Controller Area Network (CAN), or a dedicated line.

The control apparatus 22 controls individual components included in the vehicle 20. The control apparatus 22 may include at least one processor. The control apparatus 22 may include at least one dedicated circuit instead of the processor, or may include at least one dedicated circuit along with the processor. The control apparatus 22 may further include a memory.

The communication apparatus 24 communicates with the server 10 via the network 40. The communication apparatus 24 may communicate with the terminal apparatus 30 via the network 40, or may communicate with the terminal apparatus 30 without using the network 40. The communication apparatus 24 may be, for example, an in-vehicle communication device. The communication apparatus 24 may include a communication module for connection with the network 40. The communication module may include, but is not limited to, a communication module conforming to mobile communication standards, such as the 4th Generation (4G) standard and the 5th Generation (5G) standard.

The vehicle 20 further includes a position information acquisition apparatus 25, although this is not essential. The position information acquisition apparatus 25 and other components mounted in the vehicle 20 are connected so as to communicate with each other, via the in-vehicle network such as the CAN, or the dedicated line. The position information acquisition apparatus 25 acquires position information for the vehicle 20. The position information acquisition apparatus 25 may include a receiver conforming to a satellite positioning system. The receiver conforming to the satellite positioning system may include, for example, a Global Positioning System (GPS) receiver. In the present embodiment, the vehicle 20 is assumed to be capable of acquiring the position information for the vehicle 20 itself by using the position information acquisition apparatus 25. The vehicle 20 may output the position information for the vehicle 20 itself to the server 10 or the terminal apparatus 30.

The terminal apparatus 30 may communicate with the vehicle 20 via the network 40 or without using the network 40. The terminal apparatus 30 communicates with the server 10 via the network 40. The terminal apparatus 30 may include, for example, a mobile terminal such as a smartphone.

The terminal apparatus 30 may run an application that is used by the user to apply for boarding. The terminal apparatus 30 may communicate with the server 10 to transmit and receive information regarding the application for boarding. When the user boards the vehicle 20, the terminal apparatus 30 may communicate with the vehicle 20 and transmit and receive information for authenticating whether the vehicle 20 is the vehicle 20 allocated to the application from the user.

The terminal apparatus 30 may include a configuration that, for example, is identical or similar to that of the position information acquisition apparatus 25 included in the vehicle 20 to thereby acquire the position information for the terminal apparatus 30 itself. The terminal apparatus 30 may output the position information for the terminal apparatus 30 itself to the server 10 or the vehicle 20.

### Operation Example of Operation Management System 1

### Application for Boarding

The terminal apparatus 30 accepts an input from the user to apply for boarding. The terminal apparatus 30 generates boarding application information based on the input from the user, and transmits the boarding application information to the server 10. The boarding application information includes a point or an area at which the user wants to board the vehicle 20 and a point or an area at which the user wants to alight from the vehicle 20. The point or the area at which the user wants to board the vehicle 20 is also referred to as a desired point of origin. The point or the area at which the user wants to alight from the vehicle 20 is also referred to as a desired destination. The boarding application information may further include a time or a time of day at which the user wants to board the vehicle 20, or a time or a time of day at which the user wants to alight from the vehicle 20. The time or the time of day at which the user wants to board the vehicle 20 is also referred to as a desired departure time. The time or the time of day at which the user wants to alight from the vehicle 20 is also referred to as a desired arrival time. A condition that the user wants the vehicle 20 that he or she is to board to preferably satisfy is also referred to as a desired condition.

### Determination of Vehicle 20

The server controller 12 of the server 10 manages the operation of the vehicle 20 based on the boarding application information received from the terminal apparatus 30 of at least one user. The server controller 12 manages the operation of at least one vehicle 20. The server controller 12 determines the operation route or the operation schedule for the vehicle 20 based on the desired condition of the at least one user.

The server controller 12 extracts a vehicle 20 that satisfies the desired condition of the user included in the boarding application information. In a case in which a vehicle 20 satisfying the desired condition of the user does not exist, the server controller 12 may extract a vehicle 20 that, in part, does not satisfy the desired condition of the user. In the case in which a vehicle 20 satisfying the desired condition of the user does not exist, the server controller 12 may transmit, to the terminal apparatus 30, information proposing that the user change the desired condition. The terminal apparatus 30 accepts an input as to whether the user accepts a change to the desired condition. When the user accepts a change to the desired condition, the terminal apparatus 30 also accepts an input as to the condition to be changed. The terminal apparatus 30 transmits, to the server 10, the information inputted by the user. When the user has changed the desired condition, the server controller 12 extracts a vehicle 20 that satisfies the desired condition after the change.

The server controller 12 transmits, to the terminal apparatus 30, information regarding the extracted vehicle 20. The terminal apparatus 30 notifies the user of the information on the extracted vehicle 20, accepts an input as to whether the user agrees or refuses to board that vehicle 20, and transmits a result of the input to the server 10. When the user agrees to board the extracted vehicle 20, the server controller 12 determines to board the user on that vehicle 20. The vehicle 20 on which it is determined to board the user is also referred to as a boarding vehicle. When the user refuses to board the extracted vehicle 20, the server controller 12 extracts a different vehicle 20 and transmits information thereon to the terminal apparatus 30. The server controller 12 may determine the extracted vehicle 20 to be the boarding vehicle as it is.

The server controller 12 determines the operation schedule so as to board the user on the determined boarding vehicle. The server controller 12 transmits, to the boarding vehicle, a control instruction including the operation schedule. The server controller 12 transmits, to the terminal apparatus 30 of the user, information regarding the boarding point and the boarding time as determined based on the operation schedule.

### Response to Operation Demand

The vehicle 20 to which the user is boarded may be subject to demand to operate in support of various purposes. The demand for operation in support of the various purposes may be made regardless of the boarding application information from the user. The vehicle 20 may, for example, be subject to a demand to operate in support of a public purpose. The operation in support of the public purpose may include, for example in the event of an emergency, such as a disaster, or an incident or an accident, an operation for responding to the emergency. The operation for responding to the emergency is also referred to as emergency operation. The emergency operation may include, for example, an operation in which the vehicle 20 operates without driving on a road through which an emergency vehicle, such as an ambulance, a fire engine, or a police vehicle, will pass. The emergency operation may include, for example, an operation in which the vehicle 20 operates to transport a person in need of urgent transport, such as a person to be evacuated or a person to be rescued. The demand for the emergency operation is also referred to as an emergency operation demand.

The server controller 12 may receive the emergency operation demand for the vehicle 20 via the server communication interface 14, for example, from an external apparatus managed by a government, a local government, or the like. The server controller 12 may generate the emergency operation demand for the vehicle 20 based on information regarding the occurrence of the emergency, such as the disaster, or the incident or the accident.

The operation in support of the public purpose may include, for example, an operation for preferentially transporting socially vulnerable persons, such as infants and parents with an infant, elderly persons, or disabled persons.

The server controller 12 may receive or generate, as the operation demand for the vehicle 20, a demand for an operation in support of not only the public purpose but also a commercial purpose, for example. The operation in support of the commercial purpose may include, for example, the prioritized boarding of a user who satisfies various conditions, such as the payment of an additional fare. The operation in support of the commercial purpose may include the boarding of the user who has a right to preferential boarding of the vehicle 20.

Based on the received or generated operation demand for the vehicle 20, the server controller 12 changes the operation schedule for the vehicle 20. The change in the operation schedule for the vehicle 20 may cause a situation in which a user who is already on board the vehicle 20 is unable to arrive at the desired destination by a desired alighting time. Further, the change in the operation schedule for the vehicle 20 may cause a situation in which a user who is already on board the vehicle 20 is even unable to arrive at the desired destination. Further, the change in the operation schedule for the vehicle 20 may cause a situation in which the user whose application for boarding the vehicle 20 has been accepted is unable to board at the desired origin. That is, depending on the change in the operation schedule, the vehicle 20 may not be able to operate in accordance with the desired condition of a user who has applied for boarding the vehicle 20.

The server controller 12 transmits, to the terminal apparatus 30 of the user, information indicating that, due to the change in the operation schedule based on the operation demand, the vehicle 20 is unable to operate in accordance with the desired condition of the user. In a case in which the user is already on board the vehicle 20, the server controller 12 executes processing to prompt the user to alight early or to accept the delay in arrival. The server controller 12 may transmit, to the terminal apparatus 30 of the user, a request for the user to alight or a request for the user to accept the delay in arrival. In a case in which the user whose application for boarding the vehicle 20 has been accepted is not yet on board the vehicle 20, the server controller 12 executes processing to prompt the user to cancel the application for boarding, or executes processing to cancel the application from the user by the server controller 12 itself. The server controller 12 may transmit, to the terminal apparatus 30 of the user, a request for the user to cancel the application for boarding.

### Request to User Who is Already on Board Vehicle 20

The server controller 12 may transmit, to the terminal apparatus 30 of the user, a request for early alighting so as to prompt the user to alight from the vehicle on the way to the desired destination. The server controller 12 may also transmit, to the terminal apparatus 30 of the user, a request for the user to accept the delay in arrival.

The server controller 12 may transmit, to the terminal apparatus 30 of the user who is already on board the vehicle 20, information requesting acceptance of the early alighting or acceptance of the arrival at a time later than the desired alighting time. The terminal apparatus 30 may accept an input indicating whether the user accepts or rejects and transmit a result of the input to the server 10. When the user has accepted, the server controller 12 changes the operation schedule based on the content accepted by the user. When the user is to alight from the vehicle 20 early, the server controller 12 operates the vehicle 20 so that the user can alight.

When the user has rejected, the server controller 12 may change the operation schedule based on the operation demand, while enabling the user to arrive at the desired destination by the desired arrival time. In this circumstance, the server controller 12 may transmit, to the terminal apparatus 30 of another user, information requesting acceptance that it will not be possible to carry out the operation in accordance with the desired condition of that user. Even when the user has made the rejection, if it is not possible to provide the operation that satisfies the desired condition of the user, the server controller 12 may transmit, to the terminal apparatus 30 of the user, information requesting selection of either early alighting or a delay in arrival. The terminal apparatus 30 may accept an input indicating the selection from the user and transmit a result of the input to the server 10. Based on the result of the input of the user received from the terminal apparatus 30, the server controller 12 may change the operation schedule for the vehicle 20 by acknowledging that the user has accepted the early alighting or the delay in arrival. When the user does not make a selection, the server controller 12 may change the operation schedule for the vehicle 20 by assuming that the user has accepted the delay in arrival.

The vehicle 20 that the user is already on board may receive the operation schedule that has been changed based on the operation demand and operate in accordance with the received operation schedule regardless of the desired condition of the user. In this situation, the control apparatus 22 of the vehicle 20 may judge whether there is a user who satisfies the condition that, with the changed operation schedule, he or she is unable to arrive at the desired destination or is unable to arrive by the desired arrival time, among the users who are already on board. When there is a user who satisfies the condition such as that he or she is unable to arrive at the desired destination, the control apparatus 22 may inform the user who satisfies the condition of information requesting the early alighting. The vehicle 20 may include an output device, such as a display or a speaker, used to inform the user of the information. The control apparatus 22 may inform the user who satisfies the condition of the information requesting the early alighting by using the output device. The user may select either the early alighting or the delay in arrival based on the information from the vehicle 20. The terminal apparatus 30 may accept an input indicating a selection from the user and transmit a result of the input to the server 10. Based on the result of the input of the user received from the terminal apparatus 30, the server controller 12 may change the operation schedule for the vehicle 20 by acknowledging that the user has accepted the early alighting or the delay in arrival. When the user does not make a selection, the server controller 12 may change the operation schedule for the vehicle 20 by assuming that the user has accepted the delay in arrival.

### Request to User Who is Not Yet on Board Vehicle 20

The server controller 12 may transmit, to the terminal apparatus 30 of a user, a request for cancellation of the application for boarding. Without making the request, the server controller 12 may cancel the application for boarding by the server controller 12 itself and transmit information indicating the cancellation to the terminal apparatus 30 of the user.

The server controller 12 may transmit, to the terminal apparatus 30 of a user who is not yet on board the vehicle 20, information requesting acceptance of the cancellation of the application for boarding the vehicle 20. The terminal apparatus 30 may accept an input indicating whether the user accepts or rejects and transmit a result of the input to the server 10. When the user has accepted, the server controller 12 changes the operation schedule, accounting for the fact that the user will not board, and controls the vehicle 20 to operate in accordance with the changed operation schedule.

When the user has rejected, the server controller 12 may change the operation schedule based on the operation demand while enabling the user to board. In this situation, the server controller 12 may transmit, to the terminal apparatus 30 of another user, information requesting acceptance that it will not be possible to carry out the operation in accordance with the desired condition of that user. Even when the user has rejected, if it is not possible to enable the user to board the vehicle 20 in accordance with the desired condition of the user, the server controller 12 may forcibly cancel the application for boarding by the server controller 12 itself and convey the cancellation to the terminal apparatus 30 of the user.

### Granting of Incentive to User

When a user is unable to board as per the desired condition because a change has been made in the operation schedule for the vehicle 20 based on the operation demand, the server controller 12 grants an incentive to the user. The server controller 12 transmits, to the terminal apparatus 30 of the user, information regarding the incentive to be granted.

As the incentive, for example, the server controller 12 may grant a right to more preferential acceptance of an application for boarding than those by other users the next time the user applies for boarding. The server controller 12 may grant a right to have a desired condition designated the next time the user applies for boarding prioritized over those of other users.

The incentive may be granted, for example, by returning to the user a fare of the vehicle 20. The incentive may be granted, for example, as points that can be used for payment of the fare of the vehicle 20. That is, the incentive may be granted as a right relating to the fare of the vehicle 20. The incentive may be granted as electronic money. The incentive may be granted as points that can be exchanged for valuables or a paid service.

The server controller 12 may confirm that the user is a target for the granting of the incentive before granting the incentive to the user. The server controller 12 may make the user a target for the granting of the incentive when it is confirmed that the user has alighted early, accepted the delay in arrival, or cancelled the application for boarding.

The server controller 12 may confirm whether, in response to the request, the user already on board the vehicle 20 has alighted from the vehicle 20 or the user has arrived at the desired destination later than the desired arrival time. The server controller 12 may receive, from the vehicle 20 or from the terminal apparatus 30 of the user, information indicating that the user has alighted from the vehicle 20 or information indicating that the user has arrived at the desired destination later than the desired arrival time. Based on the information received from vehicle 20 or from the terminal apparatus 30 of the user, the server controller 12 may confirm the early alighting or the delay in arrival of the user. After confirming the early alighting or the delay in arrival of the user, the server controller 12 may make the user a target for the granting of the incentive and transmit, to the terminal apparatus 30, the information regarding the incentive to be granted to the user.

The server controller 12 may confirm whether the user not yet on board the vehicle 20 has cancelled his or her boarding to the vehicle 20. The server controller 12 may receive, from the vehicle 20 or from the terminal apparatus 30 of the user, information indicating that the user has cancelled boarding to the vehicle 20. Based on the information received from the terminal apparatus 30 of the user, the server controller 12 may confirm the cancellation of the boarding of the user. The server controller 12 may confirm the cancellation by canceling the boarding of the user by the server controller 12 itself. After confirming the cancellation of the boarding of the user, the server controller 12 may make the user a target for the granting of the incentive and transmit, to the terminal apparatus 30, the information regarding the incentive to be granted to the user.

### Summary

As has been described, in the operation management system 1 according to the present embodiment, when operation in support of various purposes such as a public purpose is demanded from the vehicle 20, the server 10 changes the operation schedule for the vehicle 20 based on the operation demand. The server 10 then grants an incentive to a user who is unable to board the vehicle 20 as per a desired condition. By doing so, the server 10 facilitates operation of the vehicle 20 based on the operation demand. Accordingly, operation that supports the various purposes such as the public purpose can be provided.

### Example of Flowchart Illustrating Operation Management Method

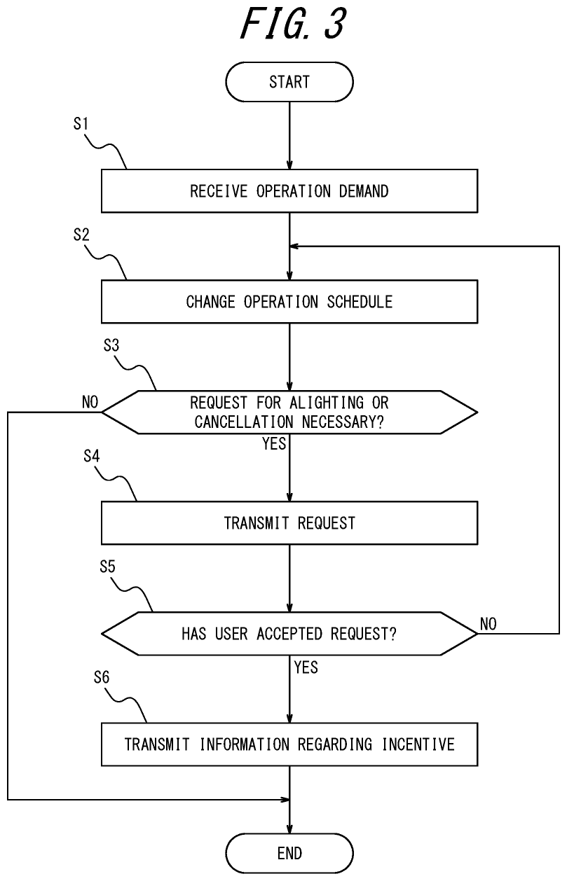

The server controller 12 of the server 10 included in the operation management system 1 may execute an operation management method including a procedure of the flowchart illustrated in FIG. 3. The operation management method may be implemented as an operation management program to be executed by a processor such as the server controller 12. The operation management program may be stored on a non-transitory computer-readable medium.

The server controller 12 receives the operation demand for the vehicle 20 (Step S1). Specifically, the server controller 12 may receive the operation demand for the vehicle 20 from the external apparatus. The server controller 12 may generate the operation demand for the vehicle 20 by the server controller 12 itself, based on information regarding a disaster, an incident or an accident, or the like.

Based on the operation demand, the server controller 12 changes the operation schedule for the vehicle 20 (Step S2). The server controller 12 may transmit the changed operation schedule to the vehicle 20. Herein, in the procedure of Step S3 or Step S5 which is described later, additional changes may be made to the operation schedule. The server controller 12 may therefore wait for a result of the judgement to be made in the procedure of Step S3 or Step S5 before transmitting the operation schedule to the vehicle 20. That is, the server controller 12 may suspend transmission of the operation schedule.

The server controller 12 judges whether it is necessary to request that the user alights, cancels, or the like. (Step S3). Specifically, the server controller 12 may judge whether there will be a user who is unable to arrive at the desired destination or a user who is unable to arrive at the desired destination by a desired arrival time due to the change in the operation schedule, among the users who are already on board the vehicle 20. The server controller 12 may judge whether there will be a user who is unable to board the vehicle 20 as per a desired condition due to the change in the operation schedule, among the users who are not yet on board the vehicle 20.

When judging that the request to the user is not necessary (Step S3: NO), the server controller 12 ends the execution of the procedure in the flowchart of FIG. 3. When the transmission of the changed operation schedule has been suspended for Step S2, the server controller 12 may execute the suspended process in the procedure of Step S3.

When judging that the request to the user is necessary (Step S3: YES), the server controller 12 transmits the request to the terminal apparatus 30 of the user (Step S4). Specifically, when there is a user who is already on board the vehicle 20, the server controller 12 may transmit, to the terminal apparatus 30 of that user, information requesting acceptance of the early alighting or information requesting acceptance of the delay in arrival. When there is a user who is scheduled to board the vehicle 20 and is not yet on board, the server controller 12 may transmit, to the terminal apparatus 30 of that user, the information requesting cancellation of the boarding.

The server controller 12 receives, from the terminal apparatus 30 of the user, information indicating whether the user has accepted or rejected the request, and judges whether the user has accepted the request (Step S5). When the user has not accepted the request (Step S5: NO), that is, when the user has rejected the request, the server controller 12 returns to Step S2 and changes the operation schedule again.

When the user has accepted the request (Step S5: YES), the server controller 12 determines an incentive to be granted to the user and transmits information regarding the incentive to the terminal apparatus 30 of the user (Step S6). When the transmission of the changed operation schedule has been suspended for Step S2, the server controller 12 may execute the suspended process in the procedure of Step S6. After executing the procedure in Step S6, the server controller 12 ends the execution of the procedure in the flowchart of FIG. 3.

As described above, according to the operation management method or the operation management program according to the present embodiment, when operation that in support of various purposes such as a public purpose is demanded from the vehicle 20, the server 10 changes the operation schedule for the vehicle 20 based on the operation demand. The server 10 then grants an incentive to a user who is unable to board the vehicle 20 as per a desired condition. This facilitates operation of the vehicle 20 based on the operation demand. Accordingly, operation that supports the various purposes such as the public purpose can be provided.

### Another Embodiment

### Determination of User Who is Subject to a Request

At the time of changing the operation schedule based on the operation demand for the vehicle 20, the server controller 12 of the server 10 requests the user to accept that the user will not be able to board the vehicle 20 as per the desired condition. The server controller 12 determines the user who is subject to the request from a user who is already on board the vehicle 20 and a user whose application has been accepted but who is not yet on board the vehicle 20.

The server controller 12 may determine the user who is subject to the request, based on an attribute of the user. The server controller 12 may set information indicating, for example, whether the user is a socially vulnerable person, such as an infant or a parent with an infant, an elderly person, or a disabled person. The server controller 12 may prioritize a user who is not a socially vulnerable person in making a request for early alighting or the like. That is, the server controller 12 may, as far as possible, avoid making the request for early alighting or the like to a user who is a socially vulnerable person. In this way, users who are socially vulnerable persons can be protected.

The server controller 12 may set the attribute of the user based on a record of the user having boarded the vehicle 20.

As the attribute of the user, the server controller 12 may set, for example, information indicating that the user has boarded the vehicle 20 a predetermined number of times or more. The server controller 12 may prioritize a user who has boarded the vehicle 20 fewer times than the predetermined number of times in making the request for early alighting or the like. That is, the server controller 12 may, as far as possible, avoid making the request for early alighting or the like to a user who has boarded the vehicle 20 the predetermined number of times or more. In this way, users can be encouraged to use the vehicle 20.

As the attribute of the user, the server controller 12 may set, for example, information indicating whether the user has previously accepted a request for early alighting or the like. The server controller 12 may prioritize a user who has not accepted a request in making the request for early alighting or the like. That is, the server controller 12 may, as far as possible, avoid making the request for early alighting or the like to a user who has accepted a request for early alighting or the like. In this way, a sense of fairness can be provided to the users.

As the attribute of the user, the server controller 12 may set, for example, information indicating whether the user has canceled an application for boarding without notice or immediately before boarding a predetermined number of times or more. The server controller 12 may prioritize a user who has made a cancellation without notice or at short notice the predetermined number of times or more in making the request for early alighting or the like. That is, the server controller 12 may, as far as possible, avoid making the request for early alighting or the like to a user who has made the cancellation without notice or at short notice fewer times than the predetermined number of times. In this way, a penalty may be imposed for the cancellation by users without notice or at short notice. The cancellation by users without notice or at short notice may be therefore prevented.

The server controller 12 may set, for the user, a priority level according to which the user is made subject to the request, based on an attribute of the user. The server controller 12 may, for example, set a higher priority level for a user who is to be preferentially made subject to the request. In this way, the server controller 12 can smoothly make the request.

### Forecast of Occurrence of Operation Demand

The server controller 12 of the server 10 receives the boarding application information from the terminal apparatus 30 of the user and accepts the application for boarding from the user. When the server controller 12 cannot generate an operation schedule for the vehicle 20 due to too many applications for boarding, the server controller 12 accepts only some of the applications to the extent that the operation schedule can be generated, without accepting the other applications.

In regard to the above, the server controller 12 may forecast the occurrence of the operation demand corresponding to the various purposes, such as the public purpose, and may determine whether to receive the boarding application information based on a result of the forecast. For example, when receiving information regarding the occurrence of an emergency, the server controller 12 may forecast that the operation demand is likely to occur so as to yield the road for passing of an emergency vehicle. Based on the result of the forecast, the server controller 12 may generate an operation schedule for driving on a road through which the emergency vehicle will not pass and receive boarding application information that conforms to the operation schedule. Further, based on the result of the forecast, the server controller 12 may reduce in advance the number of users whose applications for boarding are to be accepted.

Further, when, for example, information indicating that an increasing number of users have a right to preferential boarding to the vehicle 20 is received, the server controller 12 may forecast that operation demand is likely to occur as a result of the right to preferential boarding to the vehicle 20 being exercised. Based on the result of the forecast, the server controller 12 may reduce in advance the number of users whose applications for boarding are to be accepted.

As described above, the server controller 12 may forecast the occurrence of the operation demand and receive the boarding application information. By doing so, the server controller 12 can reduce the number of users whose applications have been accepted but who are unable to board the vehicle 20 as per their desired conditions. Consequently, the server controller 12 facilitates operation of the vehicle 20 based on the operation demand. Further, the incentives granted to the users can be reduced.

While an embodiment of the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined together or divided.

1. An operation management apparatus comprising
a controller configured to manage operation of a vehicle, wherein
the controller is configured to:
receive, from a terminal apparatus of a user, boarding application information including a desired condition of the user;
determine an operation schedule for the vehicle so as to enable the user to board the vehicle in accordance with the desired condition;
when an operation demand for the vehicle occurs, change the operation schedule based on the operation demand; and
when the user is unable to board the vehicle as per the desired condition due to the change in the operation schedule made based on the operation demand, transmit, to the terminal apparatus of the user, information regarding an incentive to be granted to the user.

2. The operation management apparatus according to claim 1, wherein
the controller is configured to, in a case in which the user is already on board the vehicle, transmit to the terminal apparatus of the user a request for the user to alight early and, when the user alights from the vehicle in response to the request, transmit to the terminal apparatus of the user the information regarding the incentive to be granted to the user.

3. The operation management apparatus according to claim 1, wherein
the controller is configured to, in a case in which the user is not yet on board the vehicle, transmit to the terminal apparatus of the user a request for the user to cancel boarding and, when the user cancels boarding to the vehicle in response to the request, transmit to the terminal apparatus of the user the information regarding the incentive to be granted to the user.

4. The operation management apparatus according to claim 2, wherein
the controller is configured to determine whether to make the request to the user based on an attribute of the user.

5. The operation management apparatus according to claim 4, wherein
the attribute of the user includes a record of the user having boarded the vehicle.

6. The operation management apparatus according to claim 4, wherein
the controller is configured to determine a priority level according to which the request is made to the user, based on the attribute of the user.

7. The operation management apparatus according to claim 1, wherein
the controller is configured to forecast the occurrence of the operation demand and accept the boarding application information based on a result of the forecast.

8. The operation management apparatus according to claim 1, wherein
the incentive includes a right to preferential acceptance of an application for boarding the vehicle from the user.

9. The operation management apparatus according to claim 1, wherein
the incentive includes a right relating to a fare of the vehicle.

10. An operation management system comprising:
the operation management apparatus according to claim 1; and
the vehicle.

11. An operation management method executed by an operation management apparatus configured to manage operation of a vehicle, the operation management method comprising:
receiving, from a terminal apparatus of a user, boarding application information including a desired condition of the user;
determining an operation schedule for the vehicle so as to enable the user to board the vehicle in accordance with the desired condition;
when an operation demand for the vehicle occurs, changing the operation schedule based on the operation demand; and
when the user is unable to board the vehicle as per the desired condition due to the change in the operation schedule made based on the operation demand, transmitting, to the terminal apparatus of the user, information regarding an incentive to be granted to the user.

12. The operation management method according to claim 11, further comprising:
in a case in which the user is already on board the vehicle, transmitting to the terminal apparatus of the user a request for the user to alight early; and
when the user alights from the vehicle in response to the request, transmitting to the terminal apparatus of the user the information regarding the incentive to be granted to the user.

13. The operation management method according to claim 11, further comprising:
in a case in which the user is not yet on board the vehicle, transmitting to the terminal apparatus of the user a request for the user to cancel boarding; and
when the user cancels boarding to the vehicle in response to the request, transmitting to the terminal apparatus of the user the information regarding the incentive to be granted to the user.

14. The operation management method according to claim 12, further comprising
determining whether to make the request to the user based on an attribute of the user.

15. The operation management method according to claim 14, wherein
the attribute of the user includes a record of the user having boarded the vehicle.

16. The operation management method according to claim 14, further comprising
determining a priority level according to which the request is made to the user, based on the attribute of the user.

17. The operation management method according to claim 11, further comprising
forecasting the occurrence of the operation demand and accepting the boarding application information based on a result of the forecast.

18. The operation management method according to claim 11, wherein
the incentive includes a right to preferential acceptance of an application for boarding the vehicle from the user.

19. The operation management method according to claim 11, wherein
the incentive includes a right relating to a fare of the vehicle.

20. A vehicle configured to:
operate based on an operation schedule and board users; and
notify a user who is on board the vehicle of information requesting early alighting when the operation schedule has been changed based on an operation demand.
